(19) United States
(12) Patent Application Publication
(10) Pub. No.: US 2004/0083703 A1
(43) Pub. Date: May 6, 2004

(54) Method and apparatus for handling a work object in movement relative thereto

(76) Inventor: David C. Crinklaw, Kingsburg, CA (US)

Correspondence Address: Rodney K. Worrel, WORREL & WORREL, St. Croix Professional Center, 2109 W. Bullard Avenue, Suite 121, Fresno, CA, 93711-1258, US

(21) Appl. No.: 10/286,497

(22) Filed: Nov. 1, 2002

(51) Int. Cl. A01D 46/00

(52) U.S. Cl. 56/330

(57) ABSTRACT

A method and apparatus for handling a work object in movement relative thereto by transmitting electrical energy along a course along which the handling is to be performed sensing the position of the electrical energy transmitted along the course and moving a handling assembly relative to the positioned sensed to perform the handling of the work object.

### CROSS-REFERENCE TO RELATED APPLICATIONS

Not applicable.

### STATEMENT REGARDING FEDERALLY SPONSORED RESEARCH OR DEVELOPMENT

Not Applicable.

### BACKGROUND OF THE INVENTION

1. Field of the Invention

The present invention relates to a method and apparatus for handling a work object in movement relative thereto and, more particularly, to such a method and apparatus which are adapted to follow a preselected course in the performance of the handling operation; which interoperate with the work object in the performance of the handling operation in such a manner that the configuration of the work object controls the path along which the handling operation is performed; which direct work performing portions thereof along one or more paths in the handling operation; which are responsive along at least one axis of reference to adjust to the configuration of the work object; which can be adapted to use in a wide variety of embodiments; and which otherwise are entirely successful in achieving their operational objectives.

2. Description of the Prior Art

It has long been known in a variety of arts to perform work operations during continuous, or substantially continuous, movement. Such a means for performing a work operation achieves a number of benefits which otherwise would be difficult, if not impossible, to accomplish. An assembly line is one example of such a process. In this example, the movement of the products being assembled through a plurality of discrete work stations for the performance of specific, progressive assembly operations permits such assembly of the product to be achieved with greater reliability and less expense than was previously possible with prior methods of assembly.

Another example of the performance of work operations during continuous movement can be observed in a variety of specific operations in agriculture. The mechanization of agriculture has seen a plethora of specific tasks, such as earth working, planting, plant and soil treatment, irrigation and harvesting, performed during continuous movement. For example, the Johnson U.S. Pat. No. 4,172,551 is directed to a linear irrigation system having a control therefor. The device of the Johnson patent is adapted to proceed in continuous movement along a channel which is employed as a source for water during irrigation. The device is controlled in such movement by a sensor which follows a signal source to direct the device in the path of travel during irrigation.

It is also known in agriculture to grow plant borne crops in parallel rows so as to facilitate the performance of farming practices relative to the plant borne crops. With the mechanization of agriculture, such techniques have advanced to the point that nearly all such farming practices can be performed by various types of mechanized devices during continuous movement along the rows.

However, such continuous mechanized operations have not been successful in a number of significant respects. The prior art devices directed to these operations have not been able precisely to follow the predetermined courses along which the performance of these operations would be preferred. This results in damage to the plants, the structures upon which the plants are supported, irrigation pipe and other subsystems as well as to the mechanized devices themselves. A consequence of such collateral damage is that the expense of such operations is exacerbated beyond that which it would otherwise be. This expense is usually either absorbed by the agricultural operation, or passed on to the consumer in the additional cost of the crop.

Still other disadvantages in such prior art processes and devices is that the equipment is complex, heavy, expensive and not as reliable as would be desirable. The consequences attendant to each of these disadvantages is readily apparent. The equipment is difficult to control; expensive to operate; damaging to the soil, root systems and plants; and otherwise burdensome to the agricultural operation.

For these and a wide variety of other disadvantages, it has long been known that it would be desirable to have a method and apparatus for handling a work object in movement relative thereto which are particularly well suited to usage in providing reliably precise guidance along a course which may be variable along its length and width; which can be operated inexpensively, with little or no training of operators; which can be employed in cooperation with otherwise conventional equipment and procedures; which are readily adaptable to a wide variety of operations, procedures, work environments and conditions; and which are particularly well suited to usage in agriculture to provide guidance for a wide variety of agricultural equipment.

### BRIEF SUMMARY OF THE INVENTION

Therefore, it is an object of the present invention to provide an improved method and apparatus for handling a work object in movement relative thereto.

Another object is to provide such a method and apparatus which are readily adaptable to a wide variety of work environments and conditions in the achievement of guidance relative to a work object.

Another object is to provide such a method and apparatus which operate cooperatively with otherwise conventional equipment and procedures.

Another object is to provide such a method and apparatus which can be employed inexpensively and with little or no training of personnel.

Another object is to provide such a method and apparatus which are particularly well suited to usage in a wide variety of agricultural work operations to provide guidance in relative movement between a work object and handling equipment.

Another object is to provide such a method and apparatus which can readily be employed, in one embodiment, in providing guidance for agricultural equipment relative to row crops and in successive application to individual rows thereof.

Another object is to provide such a method and apparatus which can be employed without any modification of the row crops or the support structures therefore.

Another object is to provide such a method and apparatus which provide guidance for agricultural equipment relative to a row crop responding to an unlimited number of variations in the course along which the equipment must be moved in the accurate performance of the work operation.

Further objects and advantages are to provide improved elements and arrangements thereof in an apparatus for the purpose described which is dependable, economical, durable and fully effective in accomplishing its intended purposes.

These and other objects and advantages are achieved, in the preferred embodiment of the present invention, in a method and apparatus employing a means defining a course relative to a work object along which travel of the apparatus can be achieved in movement relative thereto; and a system for sensing the means defining the course and operably connected to a work performing system to control movement of the work performing system relative to the work object during the performance of the work operation.

### BRIEF DESCRIPTION OF THE SEVERAL VIEWS OF THE DRAWINGS

FIG. 1 is a top plan view of the method and apparatus of the present invention shown in one operational embodiment.

FIG. 2 is a front elevation of the method and apparatus of FIG. 1.

FIG. 3 is a somewhat enlarged, fragmentary, longitudinal, vertical section of the method and apparatus of FIG. 1 showing a representative row of grapevines supported on a trellis structure and with a portion of the guidance system of the subject invention removably attached to the trellis structure.

FIG. 4 is a fragmentary, schematic diagram of a portion of the guidance system of the subject invention.

### DETAILED DESCRIPTION OF THE INVENTION

Referring more particularly to the drawings, the method and apparatus of the present invention are generally indicated by the numeral 10 in FIG. 1.

The method and apparatus 10 of the present invention can be employed in a wide variety of embodiments. The method and apparatus 10 shown in the drawings described herein are merely one such embodiment, but are particularly well suited to usage in the embodiment. More specifically, the embodiment of the method and apparatus 10 are adapted for usage in the performance of a specific agricultural work operation; that is, the pruning of the canes of grapevines grown in rows in upright relation otherwise in accordance with conventional practice. Other embodiments of the method and apparatus of the subject invention include those employed in other agricultural operations in the performance of other agricultural work operations. In addition, other embodiments of the subject invention include those employed in a wide variety of other work environments.

Referring then more particularly to the method and apparatus 10 as depicted in FIG. 1, the work environment thereof shows the earth 20 with the earth surface indicated by numeral 21. A trellis structure is generally indicated by the numeral 30 in FIG. 1. The trellis structure has a construction hereinafter to be described. It will be understood that a plurality of trellis structures 30 are mounted in the earth 20 extending upwardly from the earth surface in spaced, substantially parallel relation. As shown in FIG. 1, adjoining trellis structures are spaced so as to define a path 31 therebetween. The trellis structures can be viewed as each having a starting end portion 32 relative to the practice of the method and the operation of the apparatus, both of the subject invention.

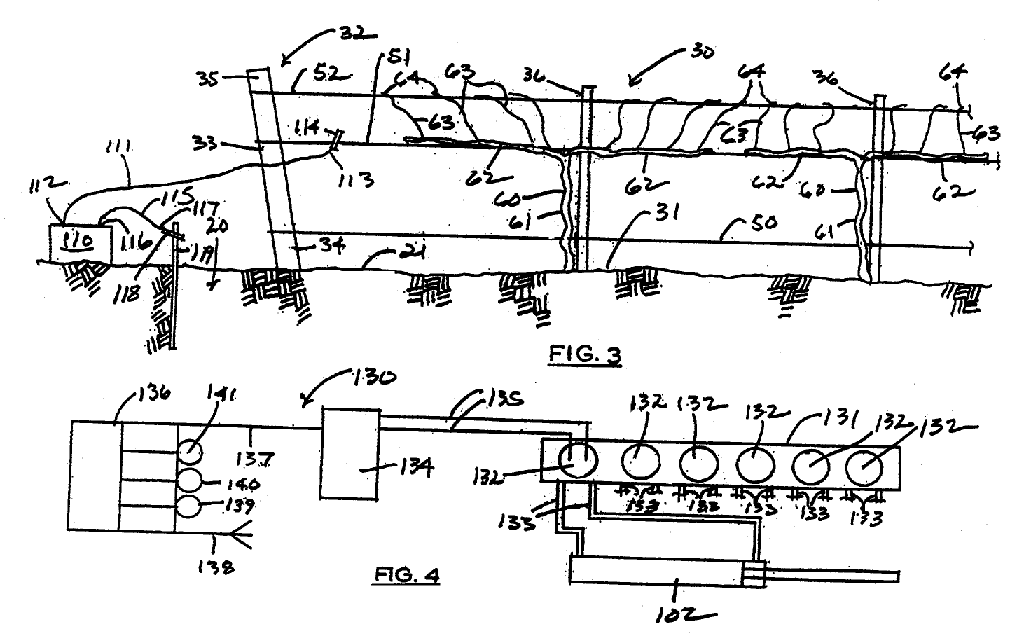

Each trellis structure 30 has a pair of end posts 33, one of which is shown in FIG. 3. It will be understood that each trellis structure has a pair of end posts, only one of which is shown in FIG. 3. The other end post of the pair of end posts of each trellis structure is at the opposite end of the trellis structure. Each end post 33 is mounted in the earth 20, extending upwardly from the earth surface 21. Each end post has a lower end portion 34 and an opposite upper end portion 35. A plurality of stakes 36 are mounted in the earth 20 in aligned, spaced relation in the trellis structure between the end posts of the trellis structure. Each of the stakes has a lower end portion 37 and an opposite upper end portion 38.

In the illustrative embodiment hereof, each trellis structure 20 has a lower wire 50, middle wire 51 and an upper wire 52. The upper wire 52 is sometimes referred to as a “catch wire.” The lower wire, middle wire and upper wire of each trellis structure have corresponding end portions 53 which are individually mounted on and extend between the end posts 33 of their respective trellis structure. The lower wire, middle wire and upper wire extend between the end posts in vertically spaced, substantially parallel relation, as shown in FIG. 3. The lower wire, middle wire and upper wire are individually attached to the stakes 36 of their respective trellis structure in vertically spaced, substantially parallel relation. The lower wire, middle wire and upper wire of each trellis structure are made of metal, or other material, which is electrically conductive. Alternatively, at least one of the three wires is made of electrically conductive material and, as shown in FIG. 3, this is the meddle wire. The material from which the electrically conductive wire is made can be of any gauge and will conduct electricity from one end to the other the entire length of the trellis structure. The electrically conductive wire can be bare or have an insulated coating. In still another embodiment, not shown, an electrically conductive wire can be buried in the earth extending directly beneath and along the trellis structure with the opposite ends thereof individually extending to predetermined attachment points above the earth surface at the opposite ends of the trellis structure.

A plurality of grapevines 60 are grown in the earth 20 in longitudinally spaced relation substantially aligned with each trellis structure 30. Each grapevine, as shown in FIG. 3, has a trunk portion 61, and at least one and, as shown in FIG. 3., two cordon portions 62. The cordon portions have a plurality of shoots or canes 63 growing therefrom and trained on the upper wire 52 of the trellis structure. The shoots have terminal ends 64.

As shown in FIG. 1, a tractor is generally indicated by numeral 70 and has a front end portion 71 and an opposite rear end portion 72. The tractor has two pairs of ground engaging wheels 73 individually mounted on the front and rear end portions thereof for earth traversing movement. The tractor is, except as herein set forth, conventional having a frame 74, engine 75, driver's station 76 and other subsystems making the tractor fully operational.

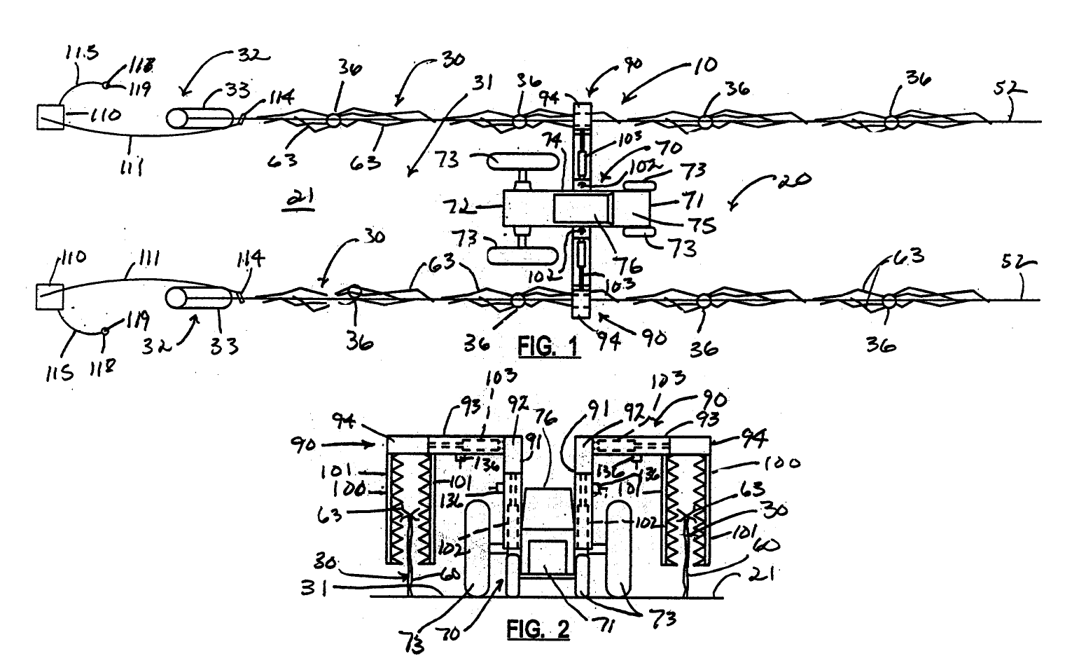

The method and apparatus 10 of the present invention include, in the illustrative embodiment hereof, a pair of pruning assemblies 90 mounted on the frame 74 of the tractor 70 on opposite sides thereof and extending laterally of the tractor in opposite directions, as shown in FIGS. 1 and 2. The pruning assemblies are preferably aligned with the driver's station, as shown. Each of the pruning assemblies is substantially identical and so one pruning assembly will be described for illustrative convenience with the understanding that the other pruning assembly is the same except that it is a mirror image of the other, as shown best in FIG. 2.

The pruning assembly 90 has a vertical beam 91 mounted on the frame 74 of the tractor 70 and extending to an upper end portion 92. A horizontal beam 93 is mounted on the upper end portion of the vertical beam for movement along a vertical path of travel on the upper end portion of the vertical beam through a predetermined range of motion. The horizontal beam extends laterally of the tractor, as shown in FIGS. 1 and 2, to a terminal end portion 94.

A cutting bar assembly 100 is mounted on the terminal end portion 94 of the horizontal beam 93 extending downwardly therefrom, as shown in FIG. 2. The cutting bar assembly is otherwise of a conventional type having a pair of spaced substantially parallel cutting subassemblies 101. The cutting bar assembly is mounted on the terminal end portion 94 of the horizontal beam 93 for movement in a predetermined range of motion along the horizontal beam towards and from the tractor 70.

The apparatus 10 of the present invention mounts a vertical hydraulic cylinder 102 operably interconnecting the vertical beam 91 and the horizontal beam 93, as shown in FIG. 2. The vertical hydraulic cylinder assembly 102 is expansible and contractible to move the horizontal beam 93 throughout its vertical range of movement. A horizontal hydraulic cylinder assembly 103 is operably mounted on the horizontal beam 93 and operably interconnects the horizontal beam and the cutting bar assembly 100 and is expansible and contractible to move the cutting bar assembly 100 throughout its range of motion of the horizontal beam.

Referring more particularly to FIG. 3, the method and apparatus 10 of the present invention include a transmitter 110 which is portable and light enough in weight to be moveable from place to place. The transmitter is preferably of low voltage frequency of from thirty (30) Hz to eighty (80) Khz. The transmitter has a positive lead wire 111 with a proximal end 112 operably connected to the transmitter and an opposite terminal end 113 upon which is mounted a clip 114.

A negative lead wire 115 is operably interconnected to the transmitter 110 and has a proximal end 116 and an opposite terminal end 117 mounting a clip 118. The clip 118 is adapted to be removably electrically connected to a stake 119 driven into the earth 20, as shown in FIG. 3. The clip 114 of the positive lead wire is adapted removably to be connected to the middle wire 51 of the trellis structure 30, as shown in FIGS. 1 and 3.

Turning then to FIG. 4, the method and apparatus 10 of the present invention include a receiving and control system generally indicated by the numeral 130. The receiving and control system includes an electric over hydraulic solenoid assembly 131 having six hydraulic valves 132. Each hydraulic valve 132 is connected to one of the hydraulic cylinders 102 or 103 of the pairs of hydraulic cylinders 102 and 103 by an individual pair of hydraulic conduits 132, as shown in FIG. 4 with respect to hydraulic cylinder assembly 102. The hydraulic solenoid assembly 131 is operably individually to control the expansion and contraction of each hydraulic cylinder 102 or 103 to which it is connected for the expansion or contraction thereof.

Each of the hydraulic valves 132 is individually connected to a booster box converter 134 by a pair of electrical conductors 135. The booster box converter is connected to a low frequency receiver 136 by an electrical cable 137. The receiver 136 mounts an antenna 138. The receiver, through the antenna receives a signal from the middle wire 51 and is able to operate the individual hydraulic valves 132 for control of its respective hydraulic cylinder assembly 102 and 103. This is determined discretely for each by a separate receiver 136 and antenna 138 through a left detector 139, center detector 140 and right detector 141.

There are, thus for receivers 136 each mounting an antenna 138 for sensing the low voltage conducted along the middle wires 51 of the trellis structures 30 bounding the path 31, as shown in FIG. 1. One receiver is individually mounted on each vertical beam 91 facing laterally of the tractor 70, as shown in FIG. 2. Similarly one receiver 136 is individually mounted on each horizontal beam 93 facing downwardly therefrom also as shown in FIG. 2.

Each receiver 136 is thus able to detect the low voltage transmitted along the middle wires 51 of the respective trellis structures during movement of the tractor 70 down the path and, by means of the left detector 139, center detector 140, and right detector 141, transmit the appropriate control voltage to the booster box converter 134 which increases the very low voltage received from one (1) volt to twelve (12) volts. The twelve (12) volt signal is then transmitted along the receivers 136 individual pair of electrical conductors 135 to operate the hydraulic cylinder assembly 102 in accordance with the signal to leave the hydraulic cylinder as is or appropriately expand or contract the respective hydraulic cylinder.

Thus, the cutting bar assemblies 100 of the pruning assemblies 90 are either left in position, raised or lowered, or moved outwardly or inwardly while following the two trellis structures 30 bounding the path 31 along which the tractor is moving. The pruning assemblies are thus individually automatically so adjusted to prune the shoots 63 of the grapevines 60 of both of the trellis structures. Upon the completion of passage of the tractor and completion of the pruning operation on the two rows of grapevines the tractor is beaded into the next path bounded by two unpruned rows of grapevines and the transmitters 110 are operably connected to the middle wires 51 of the trellis structures 30 of those rows. The method of the subject invention using the apparatus thereof is then repeated with the successive adjoining rows until the pruning operation for the vineyard is complete.

Therefore, the method and apparatus of the present invention achieves all of the objectives heretofore set forth in a manner not heretofore achieved in the art.

Although the invention has been herein shown and described in what is conceived to be the most practical and preferred embodiments, it is recognized that departures may be made therefrom within the scope of the invention which is not to be limited to the illustrative details disclosed.

Having described my invention, what I claim as new and desire to secure by Letters Patent is:

1. A method for handling a work object in movement relative thereto comprising the steps of creating a course relative to said work object capable of being sensed, establishing motion of a handling means relative to said course, sensing said course and moving said handling means in relation to said course sensed to as substantially to place said handling means in a predetermined position for said handling during said motion.

2. The method of claim 1 in which in said creating step the course is defined by the transmission of electrical therealong.

3. The method of claim 2 in which the sensing step includes sensing said electrical energy transmitted along said course in the creating step and moving said handling means relative thereto.

4. The method of claim 3 in which said course is defined by the transmission of said electrical energy along a trellis wire of a trellis structure upon which grapevines are grown.

5. The method of claim 4 in which said grapevines grow shoots which require pruning and in said handling step the shoots are pruned as positionally controlled by sensing the step.

6. An apparatus for handling a work object in movement relative thereto, the apparatus comprising a means for conducting electrical energy along a course relative to the work object along which said relative movement is desired to be established; a sensor for directing the electrical energy transmitted along said course; a handling assembly for performing the handling operation of the work object; and a control system mounted in controlling relation to the handling assembly for movement thereof relative to said electrical energy detected by said sensor.

7. The apparatus of claim 6 wherein said course is established by placing an electrical transmitter in electrical transmitting relation to an electrically conductive wire extending along said course.

8. The apparatus of claim 7 wherein the electrical energy transmitted along said wire is low voltage and the sensor includes means for increasing the voltage of said electrical energy detected by the sensor to a voltage useable by the control system in said moving of the handling assembly.

9. The apparatus of claim 8 wherein said control system includes a hydraulic system operable to move the handling assembly relative to the electrical energy detected along said course.

10. The apparatus of claim 9 wherein the work object is grapevines grown on a trellis structure, said course is defined by a trellis wire of the trellis structure and the handling assembly as operable to prune the grapevines during said relative movement.

11. The apparatus of claim 11 wherein the sensor includes at least a pair of electrical energy sensing devices operable individually to detect the position of the trellis wire vertically and horizontal during movement of the tractor along the trellis structure.
